(19) United States
(12) Patent Application Publication
(10) Pub. No.: US 2009/0087824 A1
(43) Pub. Date: Apr. 2, 2009

(54) Psychological Testing Method Using Reduced Time Period for Greater Accuracy

(76) Inventor: Leon I. Rosenberg, Cherry Hill, NJ (US)

Correspondence Address: COZEN O'CONNOR, P.C., 1900 MARKET STREET, PHILADELPHIA, PA, 19103-3508, US

(21) Appl. No.: 12/244,243

(22) Filed: Oct. 2, 2008

Related U.S. Application Data
(60) Provisional application No. 60/976,914, filed on Oct. 2, 2007.

(51) Int. Cl. G09B 19/00

(52) U.S. Cl. 434/236

(57) ABSTRACT

A method is disclosed wherein a subject of a psychological test is asked for information as to the subject's condition over the three days preceding the test, or over any interval of time less than seven days, and specifically articulating the hours and days that are to be addressed in that three-day interval or any time interval that is shorter than a one week time interval leads to more precision, less errors, and more consistency of answers from the test taker.

### CROSS-REFERENCE TO RELATED APPLICATIONS

This application claims benefit of provisional application No. 60/976,914, filed Oct. 2, 2007.

### BACKGROUND OF THE INVENTION

This invention relates to the field of psychological testing methods, and more specifically to improving accuracy of such methods.

Accuracy of information is critical for accurate completion of documentation. While some biological measures can be obtained at a specific instant in time, others are most accurately measured over a given time interval. The use of vague timelines for the collection of data can result in vague and inaccurate responses. Many of the rating scales that are used to measure the variety of states, including but not limited to the HAM-D, the HAM-A, the PANSS, the LSAS, the CGI and other depression scales, anxiety scales, and scales that measure other signs and symptoms of global or specific thinking, acting, functioning, behavior, etc., ask how someone has been over the past week. Measuring “this past week” is both too long of a measure and an inaccurate measure. It leads to inconsistencies and errors.

“This past week” or “this week” can often be taken to mean anywhere between two and seven days, depending on the context in which the phrase “this past week” is used. While some patients may always interpret “the past week” as being seven days, there is a wide variation as to how this phrase is interpreted. On a Saturday or Sunday, if patients are asked how they have been the past week, for the most part interpret this as requiring them to trace back to the previous Monday, a measure of possibly five to six days. However when patients are asked on a Wednesday or Thursday “how have you been feeling this past week,” their answers most often refer back to the Monday that is just three to four days prior to the date of questioning. When patients are asked on a Tuesday “how have you been feeling this past week,” their answers most often refer back to the Monday that is just two days prior to the date of questioning. When questioned on a Monday with “how have you been feeling this past week,” it is more likely for patients to go back seven days, a full week, rather than just two, three or four days.

Cognitive deficits are a significant component of psychiatric illness. The specifics involved in reporting on a constantly changing symptom are lost; the specifics of a constantly changing symptom over a week long interval become general as a week is often too long an interval for most people to give an accurate report on a constantly changing symptom. Not only are there the statistical errors that come as most people remember primarily the most recent event and the most significant event, (recency and primacy), these issues of recency and primacy may be more significant in this population than in most because of their problems with memory. Even if a patient would be inclined to go back a full seven days, their memory may cause them to go back fewer than seven days.

### SUMMARY OF THE INVENTION

A three day interval leaves less room for error as more specifics can be remembered over the last three days than can be remembered over the week long interval.

Any number of days less than seven days also leave less room for error as more specifics can be remembered than can be remembered over a full seven day/week long interval.

Any time interval of less than seven days also leave less room for error as more specifics can be remembered than can be remembered over a full seven day/week long interval.

A three day interval can show improvement more rapidly than a full seven day/week long interval.

Any number of days less than seven days can show improvement more rapidly a full seven day/week long interval.

Any time interval of less than seven days can show improvement more rapidly a full seven day/week long interval.

A three day interval that is being measured in a research study by one or a number of raters can measure an interval more reliably than a “week” long interval as it is always clear which days are being measured.

Any number of days less than seven days that specifies the number of days that are being measured in a research study by one or a number of raters can measure the specified interval more reliably than a “week” long interval as it is always clear which hours and/or days are being measured.

Any time interval of less than seven days that specifies the number of minutes, hours or days that are being measured in a research study by one or a number of raters can measure the specified interval more reliably than a “week” long interval as it is always clear which minutes, hours and/or days are being measured.

Psychological rating scales are used sequentially to measure change over time. Measuring a symptom three days after a change in medication has occurred using a three-day scale can show much more significant improvement than measuring a symptom three days after a change in medication has occurred on a scale that takes into account the symptom over the last seven days. Clinical research studies are now, almost invariably, limited to measuring symptoms at weekly intervals. As result they are often limited in their claims of efficacy to state the following: “we showed improvement over placebo as early as one week.” A study that measured improvement over a three day interval could demonstrate an improvement for a time frame that is shorter than one-week. This could result in efficacy data that could be used in marketing to claim more rapid onset of action than competitors who are using a scale that measures change over an interval of one week's duration.

Psychological rating scales are used sequentially to measure change over time. Measuring a symptom at a specified time interval of less than one week after a change in medication has occurred using a scale that measures a time interval of less than one week can show much more significant improvement than measuring a symptom at a specified time interval of less than one week after a change in medication has occurred on a scale that takes into account the symptom over the last seven days. Clinical research studies are now, almost invariably, limited to measuring symptoms at weekly intervals. As result they are often limited in their claims of efficacy to state the following: “we showed improvement over placebo as early as one week.” A study that measured improvement over any interval of time less than one week could demonstrate an improvement for a time frame that is shorter than one week. This could result in efficacy data that could be used in marketing to claim more rapid onset of action than competitors who are using a scale that measures change over an interval of one week's duration.

Psychological rating scales are used sequentially to measure change over time. Measuring a symptom three days after a change in medication has occurred using a three-day scale can show much more significant improvement than measuring a symptom three days after a change in medication has occurred on a scale that takes into account the symptom over the last seven days. Clinical research studies are now, almost invariably, limited to measuring symptoms at weekly intervals. A study that measured improvement over a three day interval, or any interval of time less than one week, could be conducted over a shorter period of time. This could result in the ability to perform research studies less expensively.

Psychological rating scales are used sequentially to measure change over time. Measuring a symptom at a specified time interval of less than one week after a change in medication has occurred using a scale that measures a time interval of less than one week can show much more significant improvement than measuring a symptom at a specified time interval of less than one week after a change in medication has occurred on a scale that takes into account the symptom over the last seven days. Clinical research studies are now, almost invariably, limited to measuring symptoms at weekly intervals. A study that measured improvement any interval of time less than one week could be conducted over a shorter period of time. This could result in the ability to perform research studies less expensively.

### DETAILED DESCRIPTION

By way of illustration of the benefits of using a three day scale and using it at a shorter time interval after a study is started, if a symptom that is consistently scored zero changes immediately to a score of 10 as soon as medication is introduced, and is then measured in three days, on a three day scale it will score a 10 (Scores on Days 1, 2, and 3 are 10 so the average when these three days are measured is 10.) On the other hand, if that same symptom that is consistently scored a zero changes immediately to a score of 10, when it is measured on a scale that is measuring functioning over the last week on day 3, 3 days after the medication is started, it would score only a 4.3 despite being a 10 over the last three days. (Scores on study days zero, minus 1, minus 2 and minus 3 are zero; scores on days 1, 2, and 3 are 10 so the average when these seven days are measured is 4.3.) If a symptom that is consistently scored zero changes immediately to a score of 10 as soon as medication is introduced is measured in one week on a three day scale or in one week on a one week scale, it will also score a 10. But if a symptom that has some immediate benefit is measured using a three-day scale at study day three, it is able to separate from placebo sooner and statistically with more power than when using a one week scale.

Alternatively, by way of illustration, a patient who starts out as a zero on a specific symptom or on a global measure and improves by 1 point on a daily basis after the medication is introduced presents other advantages for a three day scale. If this patient is measured after the first week either on a one week scale or a three day scale, markedly different results are obtained. On the one week scale the patient would score a 3½ after one week as the rater would average the daily scores from 1 through 7 while using the three day scale to measure the results at one week, i.e., treatment day seven, the patient would score a 6, the average of the last three day's scores, 5, 6, and 7.

Now when testing is performed and a patient is asked how they have been feeling over the last week, because the scales do not specifically articulate, “How are you feeling over the last week, by that I mean Friday, Saturday Sunday, Monday, Tuesday, Wednesday, and today,” when a patient is evaluated on a Thursday, the patient's memory about each particular day is not necessarily accessed. This invention therefore includes specifically articulating at the time of testing, the days that are to be reviewed so that the memory of the events of each day are more likely to be accessed by the patient, clarifying for the patient and the rater the days to be examined so that it is clear which time interval is being addressed. Therefore testing that incorporated this method of testing would include a phrase such as, “How have you been doing over the last three days, that is Saturday, Sunday, Monday, and today,” when the test is administered on Tuesday. Similarly, a test of any interval less than one week would be worded similarly and have advantages over the results of more vaguely worded questions.

Specifically using a three-day interval, or any interval of time less than seven days and specifically articulating the hours and days that are to be addressed in that three-day interval or any time interval that is shorter than a one week time interval leads to more precision, less errors, and more consistency of answers from the test taker. Among the many benefits, it additionally leads to a more rapid detection of change and a more significant detection of change over time at the beginning of a study, a time frame that is beneficial to demonstrate change, as it can be of significant marketing/monetary help to companies who use a three-day scale or a scale of any time interval of less than seven days. Using a shorter time scale to report symptoms will result in greater inter-rater reliability as patients are more reliable in their information and greater intra-rater reliability, as raters will always be collecting the same type of data from their subjects. This will result in an optimization of the information that is already available but that has previously been used inefficiently.

It has been discovered that collecting the information from the patient electronically, especially via computer or telephone, has advantages over collecting the information via traditional paper and pen or pencil methods.

Whereas the invention has been described in sufficient detail to enable those skilled in this art to make and use it, various alternatives and modifications should become apparent without departing from the spirit and scope of the invention.

1. A method of improving the accuracy of a psychological test comprising requesting a subject of a psychological test to provide self evaluation information as to the subject's condition over a period of the past three days.

2. The method of claim 1 wherein the information is collected electronically via computer or telephone.

3. A method of improving the accuracy of a psychological test comprising requesting a subject of a psychological test to provide self evaluation information as to the subject's condition over a specific interval of time, said interval being less than seven days, and specifically articulating the hours and days that are to be addressed in that interval.

4. The method of claim 3 wherein the information is collected electronically via computer or telephone.

5. The method of claim 1 comprising a rater gathering psychological test information about the subject.

6. The method of claim 1 comprising a rater gathering psychological test information about the subject and the rater recording it electronically.

7. The method of claim 3 comprising a rater gathering psychological test information about the subject.

8. The method of claim 3 comprising a rater gathering psychological test information about the subject and the rater recording it telephonically.
